(19) United States
(12) Patent Application Publication
(10) Pub. No.: US 2009/0112982 A1
(43) Pub. Date: Apr. 30, 2009

(54) Automatic management of associations between users

(75) Inventors: John H. Kuhlmann, Redmond, WA (US); Alan C. Lindsay, Edmonds, WA (US); Larry A. Setlow, Redmond, WA (US); Curtis L. Miller, Sammamish, WA (US)

Correspondence Address: DARBY & DARBY P.C., P.O. BOX 770, Church Street Station, New York, NY, 10008-0770, US

(73) Assignee: Wireless Services Corp., Bellevue, WA (US)

(21) Appl. No.: 11/923,498

(22) Filed: Oct. 24, 2007

(51) Int. Cl. G06F 15/16

(52) U.S. Cl. 709/204

(57) ABSTRACT

Automatically associating users of a communication system, without using an invitation or affirmative permission. In one embodiment, a first user submits contact information about a second user to a relationship system, which stores the information in the first user's contact list. Similarly, a second user submits contact information about the first user to the relationship system, which stores the information in the second user's contact list. The relationship system detects the cross reference in the two contact lists, and stores a first degree relationship between the two users. One of the users submits a request to the relationship system to enable an operation with any other user that was associated with the submitting user. Associations can also be selectively higher degrees with other users. The submitting user need not know which other users will participate in the operation, and the other users need not know the submitting user's identity.

### FIELD OF ART

The present invention is directed to managing associations between users of electronic devices, and more specifically to automatically identifying and maintaining associations between users without notifying the users or requiring consent from the users.

### BACKGROUND

Text messages, multimedia messages, email messages, and other messages have become an increasingly popular method of communication, especially with mobile devices such as cellular telephones, personal data assistants (PDAs), and the like. Such messages are generally inexpensive to send and receive relative to some voice communications, and can be communicated to multiple electronic devices at the same time. Messages can be exchanged across a variety of protocols, including those for telephones, email systems, web-based message portals, and other network systems. Some exemplary message protocols include short message service—peer to peer (SMS-PP), multimedia service (MMS), simple network paging protocol (SNPP), simple mail transport protocol (SMTP), post office protocol (POP), wireless content transport protocol (WCTP), hypertext transport protocol (HTTP), and the like.

To ease communications, users often keep contact lists that identify a name, phone number, address, and/or other identifier for communicating with other users. Such contact lists can be used to send a single message to multiple users on the list at the same time. Sometimes, a receiving user does not wish to receive message from other users who are not on the receiving user's contact list. In that case, the receiving user can indicate that messages will only be received from other users in the receiving user's contact list. Alternatively, the receiving user may receive a request from a sending user, requesting that the receiving user accept messages from the sending user. The request may be an invitation sent to one or more receiving users. If the receiving user trusts the sending user, the receiving user may opt-in by accepting the request, giving the sending user permission to send messages to the receiving user. This request/response method requires the users to interact. The request/response method also enables the sender to know which receivers will receive messages from the sender, or otherwise participate in online operations with the sender. It is desirable to enable users to associate with each other, without requiring such an invitation and reply. It is also desirable to enable users to retain some anonymity if they desire. It is with respect to these and other issues that the invention is directed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram of an exemplary server according to one embodiment of the invention;

FIG. 2 shows a functional block diagram of an exemplary mobile device according to one embodiment of the invention

FIG. 3 is a functional block diagram illustrating an overall architecture of an exemplary embodiment of the present invention;

FIG. 4 is a flow diagram illustrating example logic for an overall process of associating two clients and performing an operation based on the association;

FIG. 5 is a flow diagram illustrating example logic for associating a third client and performing an operation based on a second-degree relationship; and

FIG. 6 is a flow diagram illustrating example logic for performing an operation based on a common interest between associated clients.

### DETAILED DESCRIPTION

The present invention will now be described with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification, the term “connected” means a direct connection between the things that are connected, without any intermediary devices or components. The term “coupled,” or “in communication with” means a direct connection between the things that are connected, or an indirect connection through one or more either passive or active intermediary devices or components. The meaning of “a,” “an,” and “the” include plural references. The meaning of “in” includes “in” and “on.” The term “or” is an inclusive “or” operator, and includes the term “and/or,” unless the context clearly dictates otherwise. The phrase “in one embodiment,” as used herein does not necessarily refer to the same embodiment, although it may. Similarly, the phrase “in another embodiment,” as used herein does not necessarily refer to a different embodiment, although it may. The term “based on” is not exclusive and provides for being based on additional factors not described, unless the context clearly dictates otherwise. The term “user” can include a computer user, a mobile device user, an online service subscriber, and/or other person using an electronic device. The term “message” can include a copy of a message.

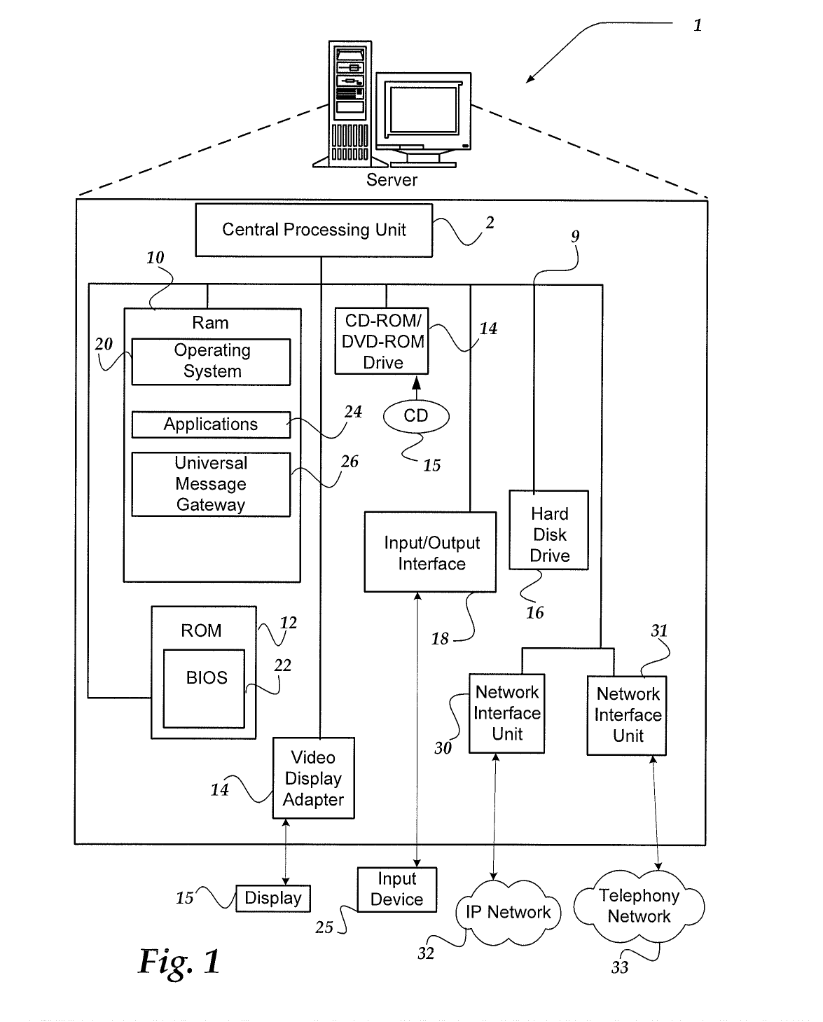

FIG. 1 shows a functional block diagram of an exemplary server 1 according to one embodiment of the invention. Server 1 may include many more components than those shown. The components shown, however, are sufficient to disclose an illustrative embodiment for practicing the invention. Client devices can be similarly configured. Client devices can include, but are not limited to, other servers, personal computers (PCs), voice mail systems, and the like. Server 1 includes a processing unit 2, a video display adapter 4 that can drive a display 5, and a mass memory, all in communication with each other via a bus 9. The mass memory generally includes RAM 10, ROM 12, and one or more permanent mass storage devices, such as an optical drive 14 that can read a machine readable medium such as a CD 15, a hard disk drive 16, a tape drive, a floppy disk drive, and/or the like. The mass memory stores an operating system 20 for controlling the operation of server 1. Any general-purpose operating system may be employed. A basic input/output system (“BIOS”) 22 is also provided for controlling low-level operation of server 1.

The mass memory also includes computer-readable media, such as volatile, nonvolatile, removable, and non-removable media implemented in any method or technology for storage of information, such as computer readable instructions, data structures, program modules, or other data. Examples of computer-readable media include RAM, ROM, EEPROM, flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computing device.

The mass memory also stores program code and data. One or more applications 24 are loaded into mass memory and run on operating system 20. Examples of application programs include database programs, schedulers, transcoders, calendars, web services, word processing programs, spreadsheet programs, email programs, and so forth. Mass storage may further include applications such as a universal message gateway 26 for managing communication to and from clients, and for managing associations among clients.

Server 1 also includes input/output interface 18 for communicating with external devices, such as a mouse, keyboard, scanner, or other input device 19. Server 1 can communicate with a local network, the Internet, a telephone network, or some other communications network via network interface units 30 and 31, which are constructed for use with one or more various communication protocols including transmission control protocol/Internet protocol (TCP/IP), user datagram protocol (UDP), code division multiple access (CDMA), time division multiple access (TDMA), global system for mobile communications (GSM), Institute for Electrical and Electronics Engineers (IEEE) 802.11, IEEE 802.16 (WiMax), short message service (SMS), general packet radio service (GPRS), Wireless Application Protocol (WAP), and the like. Network interface units 30 and 31 are sometimes known as transceivers, transceiving devices, network interface cards (NICs), and the like. The network interface units can facilitate communications between computing devices that conform to the same or differing communication protocols. For example, network interface units 30 and 31 are illustrated as communicating with networks 32 and 33, which may comprise the Internet, cellular telephone carrier networks, and/or other networks. Networks 32 and 33 also provide communication services for clients.

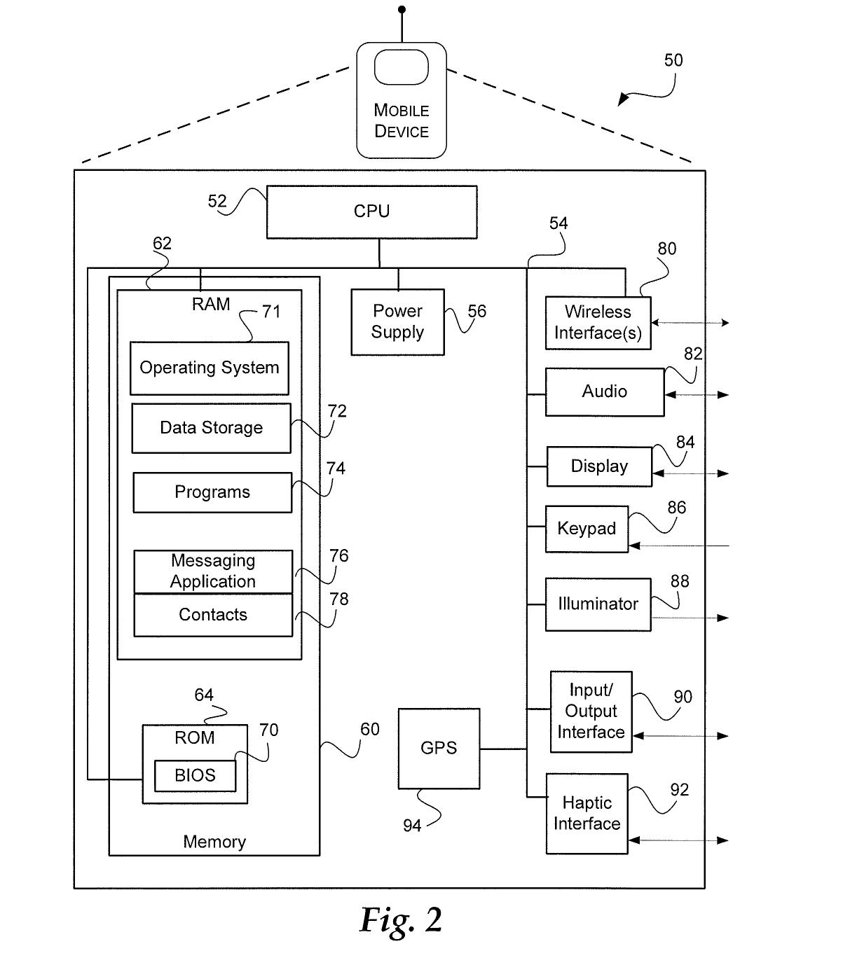

FIG. 2 shows an exemplary mobile device 50, according to one embodiment of the invention. In one embodiment, mobile device 50 is a cellular telephone that is arranged to send and receive voice communications and messages such as SMS messages via one or more wireless communication interfaces. Generally, mobile device 50 may comprise any personally mobile electronic device. Oftentimes, mobile electronic devices will be capable of personal communication by connecting to one or more wireless networks, connecting to multiple nodes of a single wireless network, communicating over one or more channels to one or more networks, or otherwise engaging in one or more communication sessions. Such devices include cellular telephones, smart phones, pagers, radio frequency (RF) devices, infrared (IR) devices, integrated devices combining one or more of the preceding devices, and the like. Mobile device 50 may also comprise other electronic devices such as Personal Digital Assistants (PDAs), handheld computers, personal computers, multiprocessor systems, microprocessor-based or programmable consumer electronics, network PCs, wearable computers, and the like.

Mobile device 50 may include many more components than those shown in FIG. 2. However, the components shown are sufficient to disclose an illustrative embodiment for practicing the present invention. As shown in the figure, mobile device 50 includes a central processing unit 52 in communication with a mass memory 60 via a bus 54.

Mass memory 60 includes a RAM 62, a ROM 64, and other storage means. Mass memory 60 illustrates another example of computer storage media for storage of information such as computer readable instructions, data structures, program modules or other data. Mass memory 60 stores a basic input/output system (“BIOS”) 70 for controlling low-level operation of mobile device 50. The mass memory also stores an operating system 71 for controlling the operation of mobile device 50. It will be appreciated that this component may include a specialized mobile communication operating system such as Windows Mobile™, or the Symbian™ operating system, or a general purpose operating system such as a version of UNIX, or LINUX™. The operating system may include, or interface with a virtual machine module, such as a Java virtual machine module, that enables control of hardware components and/or operating system operations via application programs, such as Java application programs and the like.

Memory 60 further includes one or more data storage units 72, which can be utilized by mobile device 50 to store, among other things, programs 74 and/or other data. Programs 74 may include computer executable instructions which, when executed by processor 52 and/or other components of mobile device 50, transmit, receive, and/or otherwise process data such as text, audio, video, web pages and/or other data. Other examples of application programs include browsers, contact managers, calendars, task managers, transcoders, database programs, word processing programs, spreadsheet programs, games, and so forth. A browser may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed.

In addition, mass memory 60 stores a software messaging client 76. Software messaging client 76 may include computer executable instructions, which may be run under control of operating system 71 to enable telecommunication with another user of another mobile or non-mobile device and/or manage SMS, multimedia messaging service (MMS), instant messaging (IM), email, and/or other messaging services for mobile device 50. A contacts data store 78 can also be combined with, or separate from messaging application 76.

Mobile device 50 also includes a power supply 56, one or more wireless interfaces 80, an audio interface 82, a display 84, a keypad 86, an illuminator 88, an input/output interface 90, a haptic interface 92, and an optional global positioning systems (GPS) receiver 94. Power supply 56 provides power to mobile device 50. A rechargeable or non-rechargeable battery may be used to provide power. The power may also be provided by an external power source, such as an AC adapter or a powered docking cradle that supplements and/or recharges a battery.

Mobile device 50 may optionally communicate with a base station (not shown), or directly with another mobile device. Wireless interface 80 includes circuitry for coupling mobile device 50 to one or more wireless networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), Wireless Application Protocol (WAP), ultra wide band (UWB), IEEE 802.16 Worldwide Interoperability for Microwave Access (WiMax), and the like.

Audio interface 82 is arranged to produce and receive audio signals such as the sound of a human voice. For example, audio interface 82 may be coupled to a speaker and microphone (not shown) to enable telecommunication with others and/or generate an audio acknowledgement for some action. Display 84 may be a liquid crystal display (LCD), gas plasma, light emitting diode (LED), or any other type of display used with a mobile device. Display 84 may also include a touch sensitive screen arranged to receive input from an object such as a stylus or a digit from a human hand.

Keypad 86 may comprise any input device arranged to receive input from a user. For example, keypad 86 may include a push button numeric dial, or a keyboard. Keypad 86 may also include command buttons that are associated with capturing, selecting, and/or sending images and/or other data. Illuminator 88 may provide a status indication and/or provide light. Illuminator 88 may remain active for specific periods of time or in response to events. For example, when illuminator 88 is active, it may backlight the buttons on keypad 86 and stay on while the mobile device is powered. Also, illuminator 88 may backlight these buttons in various patterns when particular actions are performed, such as dialing another mobile device. Illuminator 88 may also cause light sources positioned within a transparent or translucent case of the mobile device to illuminate in response to actions. Illuminator 88 may further be used as a flash for an image input device, such as a camera.

Mobile device 50 also comprises input/output interface 90 for communicating with internal or external devices, such as a camera, a headset, or other input or output devices not shown in FIG. 2. Input/output interface 90 can utilize one or more communication technologies, such as USB, infrared, Bluetooth™, and the like. Haptic interface 92 is arranged to provide tactile feedback to a user of the mobile device. For example, the haptic interface may be employed to vibrate mobile device 50 in a particular way when another user of a mobile device is calling.

Optional GPS transceiver 94 can determine the physical coordinates of mobile device 50 on the surface of the Earth, which typically outputs a location as latitude and longitude values. GPS transceiver 94 can also employ other geo-positioning mechanisms, including, but not limited to, triangulation, assisted GPS (AGPS), Enhanced Observed Time Difference (E-OTD), cell identifier (CI), service area identifier (SAI), enhanced timing advance (ETA), base station subsystem (BSS), or the like, to further determine the physical location of mobile device 50 on the surface of the Earth. It is understood that under different conditions, GPS transceiver 94 can determine a physical location within millimeters for mobile device 50; and in other cases, the determined physical location may be less precise, such as within a meter or significantly greater distances. In one embodiment, however, the mobile device may through other components, provide other information that may be employed to determine a physical location of the device, including for example, a MAC address, IP address, or the like.

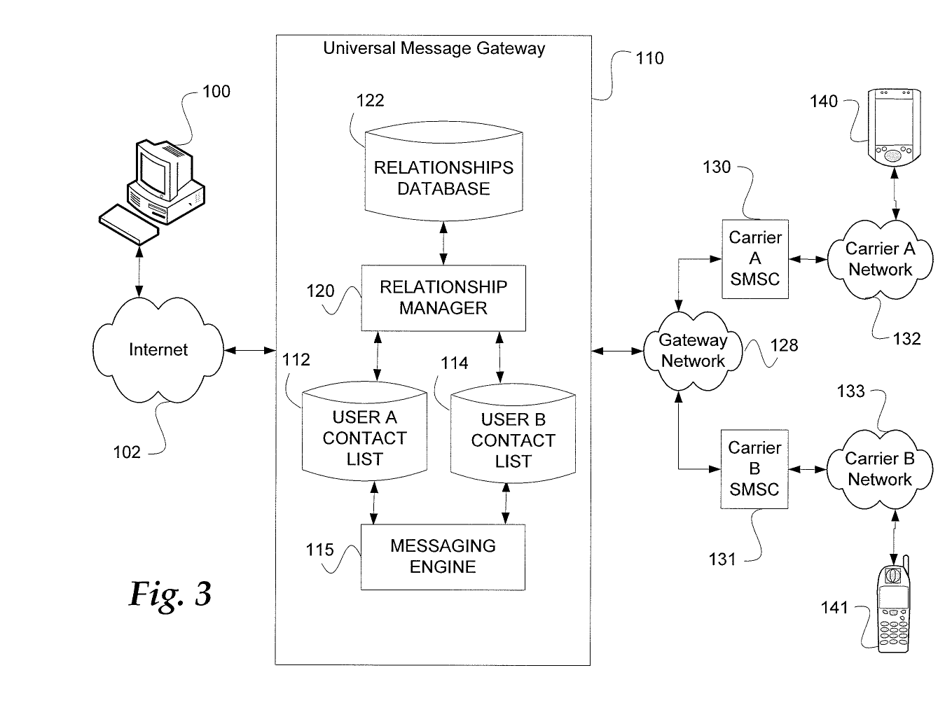

FIG. 3 is a functional block diagram illustrating an overall architecture of an exemplary embodiment of the present invention. This example embodiment is described in terms of a messaging system, but may include any system with multiple clients, such as a portal system, a gaming system, an intranet system, or the like. In this embodiment, subscribers to a messaging service may wish to share all messages, share messages within a subgroup, or enable other operations with other clients. For example, a group of friends may wish to exchange messages, participate in an online activity, participate in a game, and/or other operation. Each member of this exemplary system may use differing communication systems. Some may communicate through wired networks and others may communicate through different cellular telephone carriers. In other embodiments, participants may communicate by non-electronic means, such as orally, by written letter, or the like. Similarly, some embodiments may store information in non-electronic means, such as on paper.

In the illustrated example embodiment, a PC client 100 is shown coupled to internet 102, although PC client 100 or another device may communicate through other wired or wireless networks, such as an Ethernet network, a telephone network, and the like. A user of the PC client may also be associated with another device, such as a mobile phone. PC client 100 may be used to provide contact information about another client to a universal message gateway (UMG) 110, which may comprise one or more servers. In addition, or alternatively, PC client 100 may be used to communicate a message to UMG 110 for distribution to one or more other clients who are associated with the user of PC client 100 (or the user's other device(s)). In general, UMG 100 receives contact information from various client devices and determines associations between those clients. UMG 100 also communicates messages, or otherwise enables interaction between associated clients. In this embodiment, UMG 100 is also in communication with other clients through a gateway network 128 that is coupled to one or more communication carriers. For example, gateway network 128 may comprise T3 communication lines coupled to a carrier A short message service center (SMSC) 130 and a carrier B SMSC 131. A message or other interaction may then be communicated over a carrier A network 132 to a client 140. Similarly, a message or other interaction may be communicated over a carrier B network 133 to a client 141. The carrier networks may comprise wireless and/or wired networks using differing communication protocols, such as those listed above. Each client may submit contact information, send a message, or interact via UMG 110.

Clients 100, 140 and 141 can each be identified by a client identifier, such as a telephone number, a mobile identification number (MIN), a short code, an IP address, or other identifier. Similarly, a user account, messaging account, and/or contact list for a client user can be identified by a user identifier, such as a user ID, a telephone number, a mobile identification number (MIN), a short code, an IP address, or other identifier. To route messages from the clients to UMG 110, the UMG or each carrier generally provides one or more short codes, long codes, or other identifiers. In this exemplary embodiment, the clients direct their messages to one or more predefined short codes, which the carrier SMSCs map to the UMG. The UMG stores information from the messages and/or relays messages to other clients.

Each client device often stores contact information in a local contact list. In addition, or alternatively, each user can store contact information in UMG 110. Examples are shown as user A contact list 112 and user B contact list 114. Each user generally submits contact information in a message to a messaging engine 115 of UMG 110. Messaging engine 110 is in communication with the user contact lists. Each user may manually create a corresponding contact list, or UMG 110 may automatically create a contact list the first time that a user submits contact information for another user. When a user submits contact information for another user, the messaging engine stores the submitted contact information in the contact list of the submitting user. The user contact lists are also in communication with a relationship manager 120. Among other things, the relationship manager detects when users have submitted contact information for each other. When users store contact information for each other in their corresponding contact lists, relationship manager 120 stores an association between those users in a relationships database 122. In another embodiment, relationship manager can query the contact information stored on each client device to determine associations. The users need not notify each other of their submissions or storage of contact information. The users also need not invite each other, or obtain permission from each to establish a relationship. Relationship manager 120, messaging engine 115, and/or other modules can perform or assist with exchanging messages between related users, enabling related users to participate in games, or otherwise enable users to participate in activities with each other.

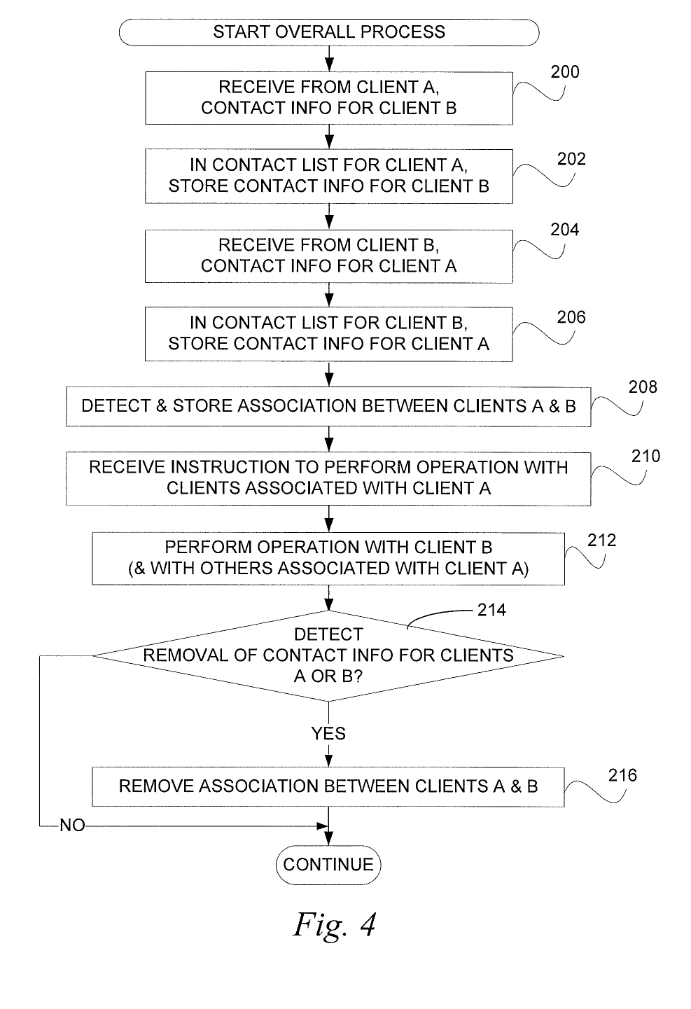

Further detail is provided below with regard to exemplary logic flow diagrams shown in FIGS. 4 through 6. FIG. 4 is a flow diagram illustrating example logic for an overall process of associating client users and enabling them to perform an operation between associated users. This example logic is described in terms of electronic operations performed by an electronic device, such as a UMG in communication with other electronic devices. Non-electronic embodiments may employ similar logic. In the illustrated example embodiment, at an operation 200, a UMG receives a message from client A that includes contact information for client B. The message may comprise an SMS text message directed to a short code of the UMG. Other message types may be used through a protocol translator, or with other embodiments that use other communication means, such as IP communication, cellular communication, email communication, paper postal mail communication, a signup sheet, or the like.

In the illustrated example, the UMG extracts the contact information of client B from the message, at an operation 202, and stores the information in a contact list for client A. A client can specify different short codes for different lists. If no contact list exists, the UMG may automatically create a contact list for client A, and store the submitted contact information of client B. Along with the submitted contact information of client B, the UMG may also store an indication that client A allows communications from, or other interaction with client B (e.g., client B is put on a client A's white list). Alternatively, a client-side application, and/or the UMG, may enable client A to select whether to allow communication from, or other interaction with client B. The client-side application, and/or the UMG, may further enable client A to specify the type(s) of communication, or other interaction, that client A will allow with client B. Default settings may be used if client A does not make any selection(s). In one embodiment, the allowed communication method(s) may be limited to the communication type(s) indicated by the contact information. For example, if client A submits a text message address as the contact information of client B, the UMG may allow client B to communicate with client A only by text message. Client A may also select whether to accept direct communication from, or otherwise directly interact with client B. Conversely, client A may select whether to accept only anonymous indirect communication via the UMG from client B. In any case, client B generally does not receive any indication that client A has added client B's contact information to client A's contact list. In another embodiment, client A may selectively instruct the UMG to notify client B that client A added client B's contact information to client A's contact list.

Similarly, at an operation 204, the UMG receives a message from client B that includes contact information for client A. The UMG extracts the contact information of client A from the message, at an operation 206, and stores the information in a contact list for client B. The other features discussed above may also be available to client B and/or applied to client B's contact list.

At an operation 208, the UMG determines that clients A and B have stored contact information for each other in their corresponding contact lists. Without notifying each client, the UMG stores an association between clients A and B. At some future point, the UMG receives an instruction, at an operation 210, to perform an operation with clients associated with client A. The instruction may come from client A, from a different client device used by a user of client A, and/or from a program module that is controlling interactions with the clients associated with client A. At an operation 212, the UMG performs the operation with client B and with any other clients that are associated with client A. The operation may comprise the sending one or more messages, performing a game operation, and/or performing another interaction with clients (or user accounts) associated with client A.

At some point, the UMG may detect removal of contact information for one of the clients, at a decision operation 214. If the UMG detects the removal of contact information from the contact list of one of the users, the UMG removes association between the removed user and the user owning the contact list, at an operation 216. For example, the UMG may receive an instruction from client A to remove the contact information for client B from client A's contact list. In this case, the UMG will automatically remove the association between clients A and B. The UMG does not need to obtain permission or another instruction from client B to remove the association.

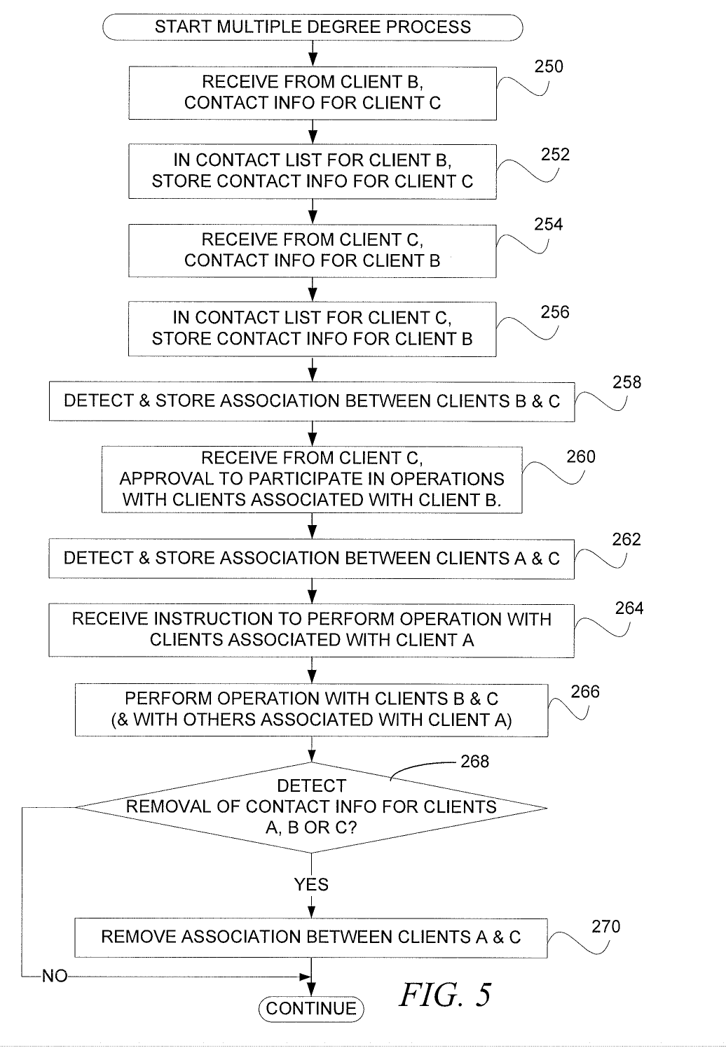

FIG. 5 is a flow diagram illustrating example logic for a process of creating a 2^{nd}-degree relationship between client users and enabling a user to perform an operation between indirectly associated users. A 2^{nd} degree relationship generally refers to an indirect relationship via an intermediary. For example, a friend of a friend may be a 2^{nd} degree relationship. A first party may have direct contact with, or other direct relationship with an intermediary party. The intermediary party may have direct contact with, or other direct relationship with a third party. The first party and the third party do not have direct contact, or other direct relationship. However, the first party and the third party have a 2^{nd} degree relationship via the intermediary party. Higher degree relationships can be established with additional intermediaries. Accordingly, 3^{rd}, 4^{th}, and/or higher degree relationships can be used in embodiments of the invention. A user may select a highest degree relationship at which the use is willing to interact with other users.

In the illustrated embodiment, at an operation 250, the UMG receives a message from client B that includes contact information for a client C. The UMG extracts the contact information of client C from the message, at an operation 252, and stores the information in a contact list for client B. Similarly, at an operation 254, the UMG receives a message from client C that includes contact information for client B. The UMG extracts the contact information of client B from the message, at an operation 256, and stores the information in a contact list for client C.

At an operation 258, the UMG determines that clients B and C have stored contact information for each other in their corresponding contact lists. Without notifying each client, the UMG stores an association between clients B and C. At an operation 260, the UMG receives a message from client C, indicating client C's approval to participate in operations with clients that are associated with client B. The UMG may store this indication as a flag or other parameter in the contact lists or a profile associated with the clients A and C. This may be a default parameter or a selected parameter, so that each user can control the degree of indirect associations with other users. For example, client A may specify that only directly associated clients can participate in operations with client A. If permitted by both clients (or all higher degree clients), the UMG stores and association between clients A and C, at an operation 262.

At some future point, the UMG receives an instruction, at an operation 264, to perform an operation with clients associated with client A. The instruction may come from client A, from a different client device used by a user of client A, and/or from a program module that is controlling interactions with the clients associated with client A. At an operation 266, the UMG performs the operation with client B and with client C. Client A may not know that client C exists. Nevertheless, client C may participate in the operation, because client C is associated with client A through client B. For example, client A may request the UMG to broadcast a message to all users that have been determined to be associated with client A. The message would be sent to client B, because clients A and B have stored each other's contact information in their corresponding contact lists. However, the message will also be sent to client C, because client C has been determined to be indirectly associated with client A by the fact that client B stores both client A's and client C's contact information in client B's contact list. Client C could respond to client A's message. The response would go through the UMG. Client C could instruct the UMG to send the reply anonymously, or could instruct the UMG to identify client C to client A. In addition, or alternatively, the response could be sent to client B. Because relationships can be established at 2^{nd}, 3^{rd}, and higher degrees, users can choose to limit the extent of the contact, or operations to specific degrees as receivers of the interaction/operation, and as transmitters of the interaction/operation.

At some point, the UMG may detect removal of contact information for one of the clients, at a decision operation 268. Relationships can be terminated by either user. This can result in severing 2^{nd}, 3^{rd}, and/or higher degree relationships through a first degree relationship. If the UMG detects the removal of contact information from the contact list of one of the users, the UMG removes the association between the removed user and the user owning the contact list, at an operation 270. In this example, the UMG may receive an instruction from client B to remove the contact information for client A from client B's contact list. In this case, the UMG will automatically remove the association between clients A and B. The UMG will also automatically remove the association between clients A and C. The UMG does not need to notify or obtain permission or another instruction from clients A or C to remove the association.

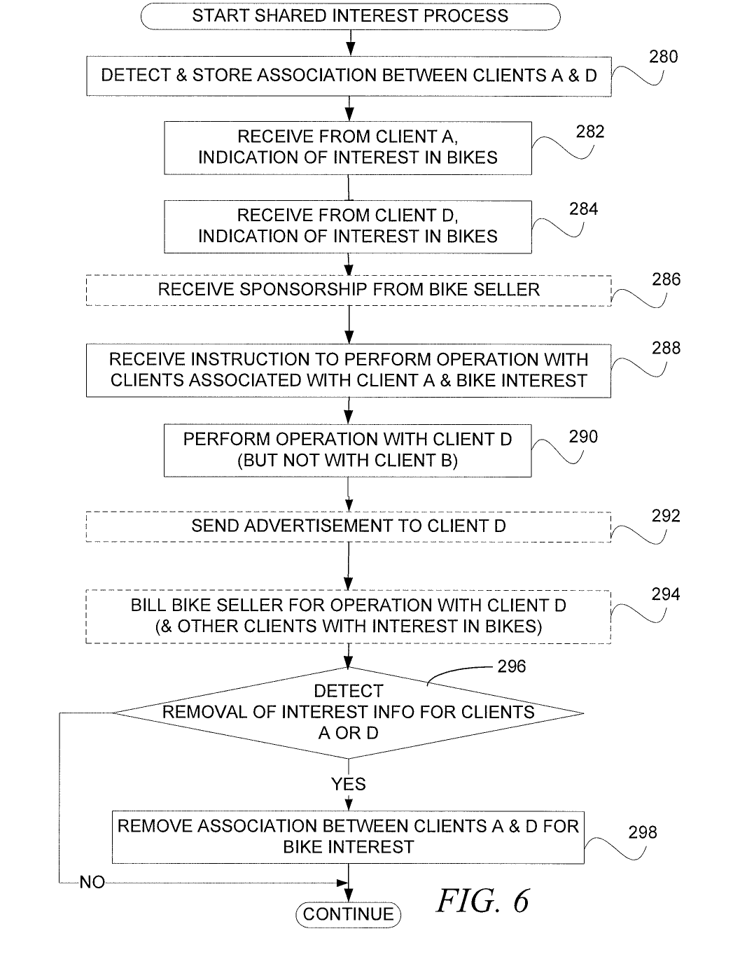

FIG. 6 is a flow diagram illustrating example logic for a process of creating a relationship between client users through a shared interest and enabling a user to perform an operation between associated users of the shared interest. At an operation 280, the UMG detects and stores and association between clients A and D in a manner described above. At an operation 282, the UMG receives an indication from client A that client A has an interest in bikes. The indication may come from joining a group, submitting a message, setting a parameter, and/or other operation. Similarly, at an operation 284, the UMG receives an indication from client D that client D has an interest in bikes. At an optional operation 286, the UMG may receive an indication that a sponsor is supporting interactions related to bikes. For example, a bike seller may sponsor interactions by paying for message costs and/or providing other benefits to participants.

In this example, the UMG receives an instruction at an operation 288 to perform an operation with clients that are associated with client A and that have indicated an interest in bikes. The UMG enables the operation with client D at an operation 290. The UMG does not enable the operation with client B, because client B has not indicated an interest in bikes. As part of a sponsorship arrangement, the UMG may send an advertisement to client D at an optional operation 292. Also according to the arrangement, the UMG may optionally send a bill to the bike seller for the operation with client D, at an optional operation 294. The operation, advertisement, and bill, would also be applied for other clients that are associated with client A and that have indicated an interest in bikes.

At some point, the UMG may detect removal of the interest for one of the clients, at a decision operation 296. If the UMG detects the removal of the interest from one of the associated users, the UMG removes the association between the removing user and other users who remain interested in bikes, at an operation 298. In this example, the UMG may receive an instruction from client D to remove the interest in bikes. In this case, the UMG will automatically remove the association between clients A and D. The UMG will also automatically remove the association between clients D and any other client that remains interested in bikes. The UMG does not need to notify or obtain permission or another instruction from any of the clients to remove the association.

The above specification, examples, and data provide a complete description of the manufacture and use of the composition of the invention. For example, the UMG may interact with other modules and/or other servers to perform a variety of other operations. Examples operations may include a messaging game, a voting game, a war game, a game of acquiring members in a group, a talent competition, a trivia game, and the like. Various messaging races may include the following.

Quickly entering identifiers in an attempt to automatically associate users from a start location to a destination location (e.g., from New York to Los Angeles).

Quickly entering identifiers in an attempt to automatically associate users within an area (e.g., all rooms in a building, all 50 states of the United States, all countries in the world, etc.).

A voting game may comprise entering identifiers to establish associations that form a tribe, and then entering votes to exclude someone from the tribe, reduce someone's voting power, elect a leader, and/or other voting process. Another voting operation may comprise determining a number of contact lists which includes each identifier to determine who might be most popular. Rather than comparing contact lists, user identifiers may be submitted to a specific short code during a predefined period to create a single database of votes and determine which user identifier gets the most votes. A variation may be to determine which identifier was entered by the most number of unique submitting identifiers. The top vote-getter may receive a message asking for an image or other information that is displayed to others, broadcast on a television show, included in an advertisement, or the like. A further voting operation may comprise submitting text messages to short codes that represent various groups, and associating users between the groups. The groups may be combined when an association is formed between two users in the groups. The groups can continue to combine until a final pair of users are associated to form a final, single large group. The association of the final pair may be considered a golden spike that links the groups, and the final pair of users may win a prize.

A war game may comprise entering identifiers to establish associations that form competing groups, and then entering identifiers of members of an opposing group to knock out those members from the opposing group, to virtually capture those members, to have those members converted to one's own group, to score a point, to remove an opponent's points, or the like. A targeted member may rejoin their group by reentering a group member's identifier, a group identifier, or the like. Additional information may be included in submissions, or broadcast to associated users. For example, information about weapons, location, or the like may be submitted or broadcast. Associations may be made between the additional information to determine capabilities or characteristics of a group.

A trivia game or other action game may require users to submit answers to messages broadcast to associated users. Points may be obtained for answers and prizes awarded.

In any game or other operation, a charge may be applied for individual actions, for a limited number of actions, for a period of time, or the like. In addition, or alternatively, one or more advertisements may be sent to users during participation in any operation. Users may provided an opportunity to join or opt-in to participate. The operations may also interact with external services such as online portals, television shows, sponsors, and the like.

Since many embodiments of the invention can be made without departing from the spirit and scope of the invention, the invention resides in the claims hereinafter appended.

What is claimed as new and desired to be protected by Letters Patent is:

1. A computer implemented method for associating clients of an electronic network, comprising:
receiving from a first client, contact information of a second client that enables communication with the second client over the electronic network;
storing the second client's contact information in a contact list for the first client;
receiving from the second client, contact information of the first client that enables communication with the first client over the electronic network;
storing the first client's contact information in a contact list for the second client;
detecting the second client's contact information in the first client's contact list and the first client's contact information in the second client's contact list; and
automatically associating the first client and the second client without further input from the first client and without further input from the second client.

2. The method of claim 1, wherein the electronic network includes at least one of the following; a cellular communications network, an internet, and an intranet.

3. The method of claim 1, wherein at least one of the first client's contact information and the second client's contact information is received through a cellular communication network.

4. The method of claim 1, wherein at least one of the first client's contact information and the second client's contact information comprises one of the following; a telephone number, a mobile identifier, an email address; an instant messaging address; and a user identifier.

5. The method of claim 1, further comprising at least one of the following:
storing the association in an association database;
storing an indication that communication is allowed from the second client to the first client; and
storing a preference as to a highest degree of relationship that the first client will interact with another client.

6. The method of claim 1, further comprising:
receiving a request from the first client to perform an operation, wherein the request does not identify the second client;
performing the operation with the second client.

7. The method of claim 6, wherein the operation comprises one of the following; sending a message, participating in a game, and participating in a collaborative activity.

8. The method of claim 1, further comprising:
receiving an instruction to remove the second client's contact information from the first user's contact list;
automatically disassociating the first client and the second client.

9. The method of claim 1, further comprising:
receiving a third client's contact information from the second client;
associating the third client with the first client with a multiple degree relationship;
receiving a request from the first client to perform an operation with another client, wherein the request does not identify the other client;
performing the operation with the second client and the third client.

10. The method of claim 9, further comprising:
receiving from the first client, contact information of a third client that enables communication with the third client over the electronic network;
storing the third client's contact information in a contact list for the first client;
receiving from the third client, contact information of the first client that enables communication with the first client over the electronic network;
storing the first client's contact information in a contact list for the third client;
detecting the third client's contact information in the first client's contact list and the first client's contact information in the third client's contact list; and
automatically associating the first client and the third client without further input from the first client and without further input from the third client.
receiving from the first client an indication of an interest;
receiving from the third client an indication of the interest;
receiving a request from the first client to perform an operation related to the interest, wherein the request does not identify the second client and does not identify the third client;
performing the operation with the third client.

11. A computer readable medium storing computer executable instructions that cause an electronic device to perform the actions of claim 1.

12. A system for associating clients of an electronic network, comprising:
a communication interface in communication with the electronic network;
a processor in communication with the communication interface; and
a memory storing data and machine readable instructions that cause the processor to perform at least the actions of:
receiving from a first client, contact information of a second client that enables communication with the second client over the electronic network;
storing the second client's contact information in a contact list for the first client;
receiving from the second client, contact information of the first client that enables communication with the first client over the electronic network;
storing the first client's contact information in a contact list for the second client;
detecting the second client's contact information in the first client's contact list and the first client's contact information in the second client's contact list; and
automatically associating the first client and the second client without further input from the first client and without further input from the second client.

13. The system of claim 12, wherein at least one of the first client's contact information and the second client's contact information is received through a cellular communication network.

14. The system of claim 12, wherein the machine readable instructions further cause the processor to perform at least one of the actions of:
storing the association in an association database;
storing an indication in the association database that communication is allowed from the second client to the first client; and
storing a preference as to a highest degree of relationship that the first client will allow interaction with another client.

15. The system of claim 12, wherein the machine readable instructions further cause the processor to perform the actions of:
receiving a request from the first client to perform an operation, wherein the request does not identify the second client;
performing the operation with the second client.

16. The system of claim 15, wherein the operation comprises at least one of the following; sending a message and participating in a game.

17. The system of claim 12, wherein the machine readable instructions further cause the processor to perform the actions of:
receiving an instruction to remove the second client's contact information from the first user's contact list;
automatically disassociating the first client and the second client.

18. The system of claim 12, wherein the machine readable instructions further cause the processor to perform the actions of:
receiving a third client's contact information from the second client;
associating the third client with the first client with a multiple degree relationship;
receiving a request from the first client to perform an operation with another client, wherein the request does not identify the other client;
performing the operation with the second client and the third client.

19. A message gateway, comprising:
a communication interface in communication with a plurality of clients;
a first user contact list data store;
a second user contact list data store;
a relationships data store; and
a relationship manager in communication with the communication interface, with the first user contact list data store, with the second user contact list data store, and with the relationships data store, wherein the relationship manager includes instructions that cause the relationship manager to perform a plurality of operations, including:
receiving from a first user, contact information of a second user that enables communication with the second user;
storing the second user's contact information in the first user's contact list data store;
receiving from the second user, contact information of the first user that enables communication with the first user;
storing the first user's contact information in the second user's contact list data store;
detecting the second client's contact information in the first user's contact list data store and the first client's contact information in the second user's contact list data store; and
automatically associating the first user and the second user without further input from the first user and without further input from the second user.

20. The message gateway of claim 19, wherein the instructions further cause the relationship manager to perform the operations of:
receiving a request from the first user to perform an operation, wherein the request does not identify the second user;
performing the operation with the second user.

21. A method for associating participants in a communication process, comprising:
receiving from a first participant, contact information of a second participant that enables communication with the second participant;
storing the second participant's contact information in a contact list for the first participant;
receiving from the second participant, contact information of the first participant that enables communication with the first participant;
storing the first participant's contact information in a contact list for the second participant;
detecting the second participant's contact information in the first participant's contact list and the first participant's contact information in the second participant's contact list; and
associating the first participant and the second participant without further input from the first participant and without further input from the second participant.
